(19) United States
(12) Patent Application Publication
(10) Pub. No.: US 2007/0095739 A1
(43) Pub. Date: May 3, 2007

(54) Utility transfer apparatus, stage apparatus, exposure apparatus, and device manufacturing method

(75) Inventor: Akimitsu Ebihara, Fukaya-shi (JP)

Correspondence Address: OLIFF & BERRIDGE, PLC, P.O. BOX 19928, ALEXANDRIA, VA, 22320, US

(73) Assignee: NIKON CORPORATION, TOKYO (JP)

(21) Appl. No.: 11/584,633

(22) Filed: Oct. 23, 2006

Related U.S. Application Data
(60) Provisional application No. 60/732,637, filed on Nov. 3, 2005.

(30) Foreign Application Priority Data
Oct. 24, 2005 (JP) P2005-308327

(51) Int. Cl. C02F 1/48; B24B 51/00; B01D 35/06; B24B 49/00; B03C 1/02; B03C 1/30

(52) U.S. Cl. 210/222; 451/11; 210/223

(57) ABSTRACT

A utility transfer apparatus includes: a magnetic member being secured to a first member; a first coil provided on the first member and wound on the magnetic member; and a second coil provided on a second member and wound on the magnetic member so that the second member is movable relative to the first member. The magnetic member forms a magnetic circuit that does not have an air gap.

### CROSS-REFERENCE TO RELATED APPLICATION

This application is non-provisional application claiming benefit of provisional application No. 60/732,637, filed Nov. 3, 2005, and claims priority to Japanese Patent Application No. 2005-308327, filed on Oct. 24, 2005, the contents of which are incorporated herein by reference.

### BACKGROUND OF THE INVENTION

1. Field of the Invention

The present invention relates to a utility transfer apparatus that performs non-contact transmission of electrical utilities such as electric power, electrical signals, etc.; a stage apparatus; an exposure apparatus; and a device manufacturing method that uses this exposure apparatus.

2. Description of Related Art

In general, a power cable for supplying electric power and signals is connected to a stage having a drive device such as a motor that performs driving using electric power. Alternatively, a battery is loaded on the stage. In this configuration, large increases in the number of wires became a bottleneck in terms of cable reliability. This is the same as in the configuration having a joint such as an articulated actuator of a robot.

In the configuration having a separate and independent electric motor, one assembly that uses E-type core, etc. for supplying electric power by electromagnetic induction, has been proposed. One example thereof is disclosed in Japanese Unexamined Patent Application, Publication No. H06-006993. The example prepares a pair of those in which coils are wound on an E-type core formed of steel, etc. and mutually provides air gaps to supply electric power to a separate and independent electric motor regardless of the non-contact status.

However, there is an air gap between the pair of E-type cores, so the magnetic flux or the magnetic circuit is interrupted, and that the magnetic flux leaks from the air gap. This magnetic flux leakage leads to a reduction in the efficiency of electric power supply.

### SUMMARY OF THE INVENTION

An object of the present invention is to provide a utility transfer apparatus with reducing magnetic flux leakage. The utility transfer apparatus can be applied to, for example, laptop personal computers, cellular telephones or equipment that has folding mechanisms such as doors and apparatus such as exposure apparatuses that have members that perform fine movement.

An aspect of a utility transfer apparatus according to the present invention comprises: a magnetic member being secured to a first member; a first coil provided on the first member and wound on the magnetic member, and a second coil provided on a second member and wound on the magnetic member so that the second member is movable relative to the first member, wherein the magnetic member forms a magnetic circuit that does not have an air gap. Another aspect of a utility transfer apparatus according to the present invention comprises: a first member; a second member that is movable relative to the first member; a magnetic member that is secured to one of the first member or the second member and forms a closed magnetic circuit; a first coil that is provided on the first member and is wound on the magnetic member, and a second coil that is provided on the second member and is wound on the magnetic member so as to be capable of relative movement with respect to the magnetic member.

Through this configuration, it is possible to transfer electrical utility, such as in supplying and receiving electric power, in a status in which there is little magnetic flux leakage even if it is a second member that moves a prescribed distance. For this reason, when electric power is supplied to an independent and separate second member, cables, etc. need no longer be used, and reliability and durability improve.

In addition, an exposure apparatus according to the present invention comprises a previously described utility transfer apparatus.

Therefore, in the exposure apparatus of the present invention, for example, in a fine movement stage that performs precise movement, in particular it is possible to perform utility transfer in a status in which there is little magnetic flux leakage, and it is possible to achieve efficient exposure processing.

In addition, a device manufacturing method of the present invention uses a previously described exposure apparatus.

Therefore, with the present invention, it is possible to manufacture devices efficiently,

### BRIEF DESCRIPTION OF THE DRAWINGS

FIG. 1 is a drawing that shows an electric power supplying and receiving apparatus in which a ring core is used as the magnetic body.

FIG. 2 is a drawing that shows an electric power supplying and receiving apparatus in which a rectangular roundness core is used as the magnetic body.

FIG. 3 is a drawing that shows another electric power supplying and receiving apparatus in which a rectangular roundness core is used as the magnetic body.

FIG. 4 is a drawing that shows the &at that an insulating member is arranged between the secondary coil and the core.

FIG. 5 is a drawing that shows an electric power supplying and receiving apparatus in which a rectangular roundness cut core that is cut in two is used as the magnetic body.

FIG. 6 is a specific block diagram of one embodiment.

FIG. 7 is an explanatory drawing in which alternating current three-phase signals are superposed and sent to the secondary coil.

FIG. 8 is a drawing in which an electric power supplying and receiving apparatus has been applied to a laptop personal computer.

FIG. 9 is a drawing in which an electric power supplying and receiving apparatus has been applied to an exposure apparatus.

FIG. 10 is a flow chart that shows an example of the semiconductor device manufacturing process.

### DESCRIPTION OF THE PREFERRED EMBODIMENTS

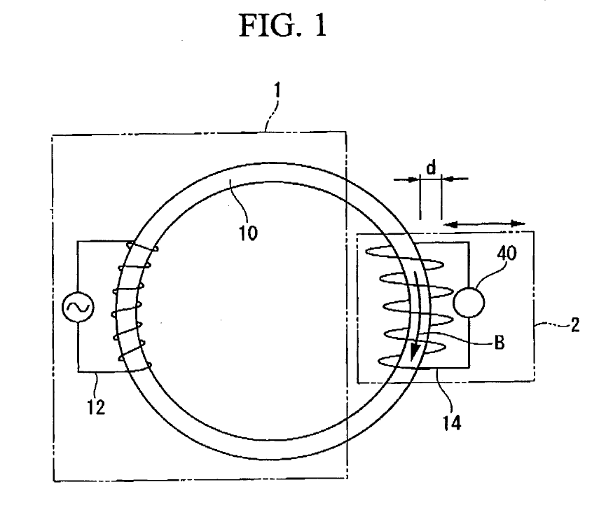

FIG. 1 is a drawing that shows a first embodiment of the present invention, and it shows an electric power supplying and receiving apparatus that uses a ring core as the magnetic body. A material that has little magnetic flux leakage is used for the ring core 10 of FIG. 1. For example, steel, cobalt, nickel, silicon steel or an amorphous alloy is used. As shown in FIG. 1, in a first member 1 which is the fixed side, a primary coil 12 is tightly wound onto the ring core 10. The first member 1 and the ring core 10 are sewed with the primary coil 12. Alternating current or high frequency current is applied at the prescribed voltage to the primary coil 12 made of copper.

A secondary coil 14 is wound onto the ring core 10 and is secured to a second member 2, which is the moving side. A load resistor 40 that has resistance, such as an electric lamp or a motor, is connected to the secondary coil 14. The number of windings of the primary coil 12 and the number of windings of the secondary coil are respectively determined according to the demand voltage of the load resistor. For example, if number of windings of the primary coil 12 is twice the number of windings of the secondary coil 14, and 200 V has been applied to the primary coil 12, 100 V is output to the secondary coil 14.

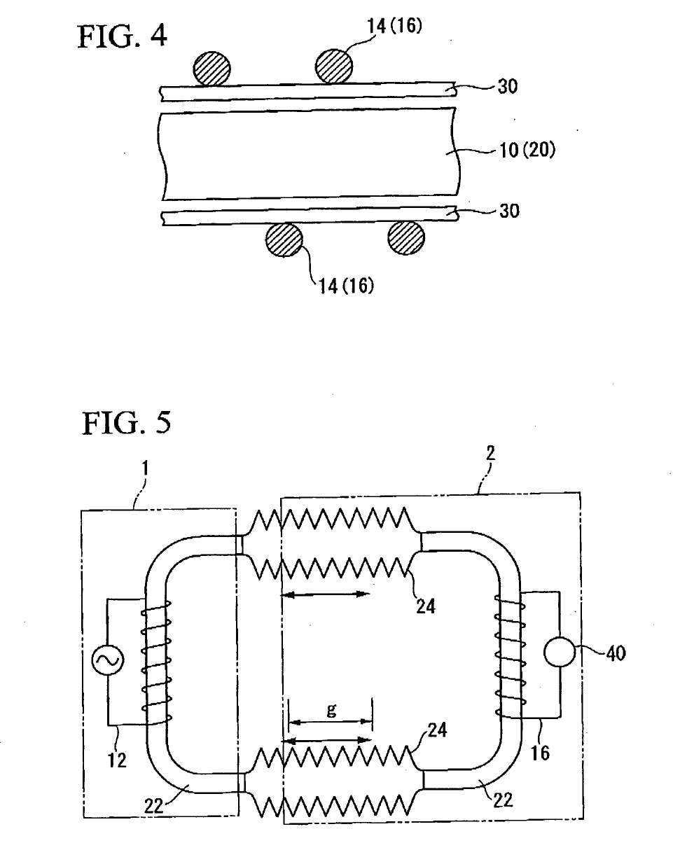

The secondary coil 14 is such that a gap of at least distance “d” is formed between the outer circumference portion of the ring core 10 and the inner circumference portion of the secondary coil 14 so that movement is possible in the diction of the arrows in FIG. 1, that is, a direction that intersects the direction of the magnetic circuit (magnetic flux) formed by the ring core 10 on which the secondary coil 14 is wound. The load resistor 40 is an actuator such as a linear motor or a voice coil motor, and furthermore in to case where this linear motor is arranged so that it is able to drive the secondary coil 14 in the diction of the arrows with respect to the primary coil 12 (ring core 10), when a voltage is applied to the primary coil 12, the secondary coil 14 (second member 2) is able to move within the range of distance “d” in the direction of the arrows by means of the linear motor, which has received supply of electric power via the secondary coil 14. The secondary coil 14 moves, so it is preferable that an insulating member 30 (see FIG. 4) that has little friction be provided so that problems do not occur even if it comes into contact with the ring core 10. An example of the insulating material is a plastic material such as tetrafluoroethylene or polyamide.

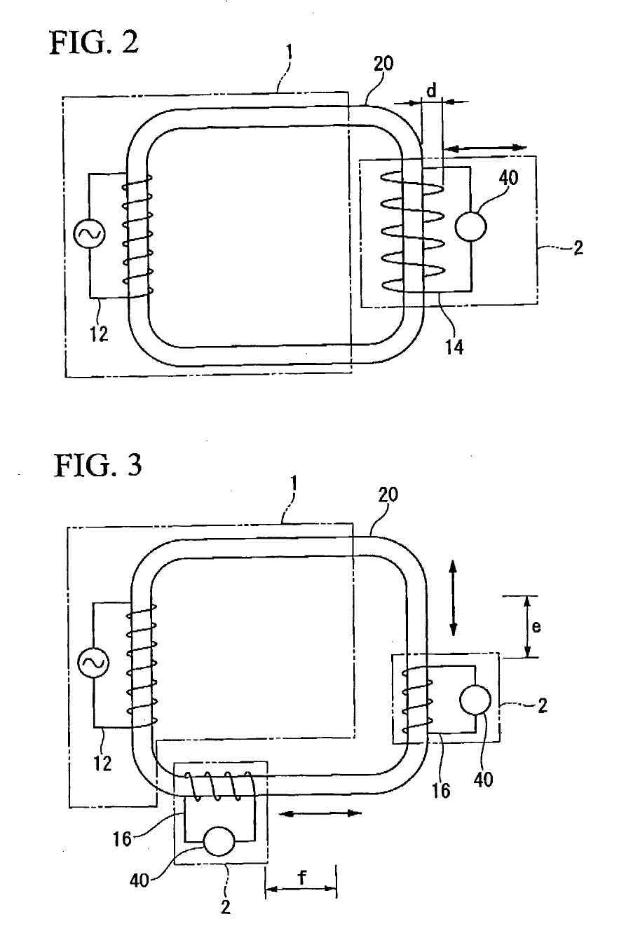

FIG. 2 is a drawing &at shows a second embodiment of the present invention, and it shows au electric power supplying and receiving apparatus (utility transfer apparatus) that us a rectangular roundness core as the magnetic body. In the same way as in the first embodiment, steel, cobalt, nickel, silicon steel or an amorphous alloy is used for the roundness core 20 of FIG. 2 as well. The primary coil 12 in FIG. 2 is the same as in the first embodiment, and the secondary coil 14 is also configured in the same way. In addition, the primary coil 12 and the roundness core 20 are secured to the first member 1, which is the fixed side, and the second coil 14 is secured to second member 2, which is the moving side. A gap of at lea distance “d” is formed between the outer circumference portion of the roundness core 20 and the inner circumference portion of the secondary oil 14. So in the same way as in the configuration in FIG. 1, the secondary coil 14 (second member 2) can be moved within the range of distance “d” in the direction of the arrows (a direction that intersects the magnetic flux formed by the roundness core 20).

FIG. 3 is a drawing that shows a third embodiment of the present invention, and it shows an electric power supplying and receiving apparatus that uses a rectangular roundness core as the magnetic body. The primary coil 12 and the roundness core 20 are secured to the first member 1, which is the fixed side, and secondary coils 16 are secured to second members 2, which are the moving sides. FIG. 3, the first secondary coil 16 is arranged on one side of the regular roundness core 20, and the second secondary coil 16 is arranged on another side. A material that has a little magnetic flux leakage is used for the roundness core 20 in FIG. 3 as well in the same way as in the first embodiment. The primary coil 12 in FIG. 3 is configured in the same way as in the first embodiment. In addition, the respective secondary coils 16 are such that a gap is formed between the outer circumference portion of the roundness core 20 and the inner circumference portion of the secondary coils 16 so that they are respectively able to move in the directions of the arrows in FIG. 3. In the example shown in FIG. 3, secondary coils 16 are configured so that they move along the direction of the magnetic circuit (magnetic flux) formed by the roundness core 20 and so that they hardly move at all in a direction that intersects that magnetic circuit (magnetic flux). For this reason, the gap between the outer circumference portion of the roundness core 20 and the inner circumference portion of the secondary coils 16 should be set to a degree at which this core 20 and coils 16 are able to move in the direction of the arrows without coming into contact. Then, if the load resistors 40 are actuators such as linear motors, and these linear motors are arranged so that they are able to drive secondary coils 16 in the direction of the arrows (in a direction along the magnetic circuit (magnetic flux) formed by the roundness core 20), when a voltage is applied to the pray coil 12, the respective secondary coils 16 (second members 2) move in the directions of the arrows in a range of a distance “e” or a distance “f” by mans of the linear motors that have received supply of electric power via the secondary coils 16.

Distance “e” or distance “f” may be freely determined according to the shape of the roundness core 20. In addition, a low friction resistance member is arranged between the secondary coils 16 and the roundness core 20.

In the first embodiment tough the third embodiment, a ring core 10 and a rectangular roundness core 20 are shown, but it is not limited to these shapes, and it may be a core with an elliptical shape, a triangular shape or a polygonal shape. However, it is necessary for the core to be a closed path so that the magnetic circuit or the magnetic flux is not interrupted by air gaps. In addition, it is also possible is to set not only the shape of the core but the arrangement, etc. of the respective coils with respect to the core as desired, for example, setting may be appropriately performed according to the movement range and shape, etc. of the moving side (second member 2).

FIG. 4 shows a cross section of the ring core 10 or the roundness core 20 of the secondary coil 14 (or 16) in the first embodiment through the third embodiment. An insulating member 30 that has little friction is provided between the secondary coil 14 (or 16) and the core. An example of the insulating material is a plastic material such as tetrafluoroethylene or polyamide. In FIG. 4, a coil 14 (or 16) is a wound onto the insulating member 30, but the insulating member 30 may also be molded as a unit with the core, and the insulating member 30 need not be connected to the core or the coil.

In addition, in the case where a prescribed strength is required of this coil portion to prevent deformation, etc. of the secondary coil 14, 16, the coil 14, 16 may be hardened with a resin, etc. and secured as a unit. In the case where a coil 14 (or 16) has been wound onto the insulating member 30, strength may be provided by forming these coils and the insulating member 30 as a unit.

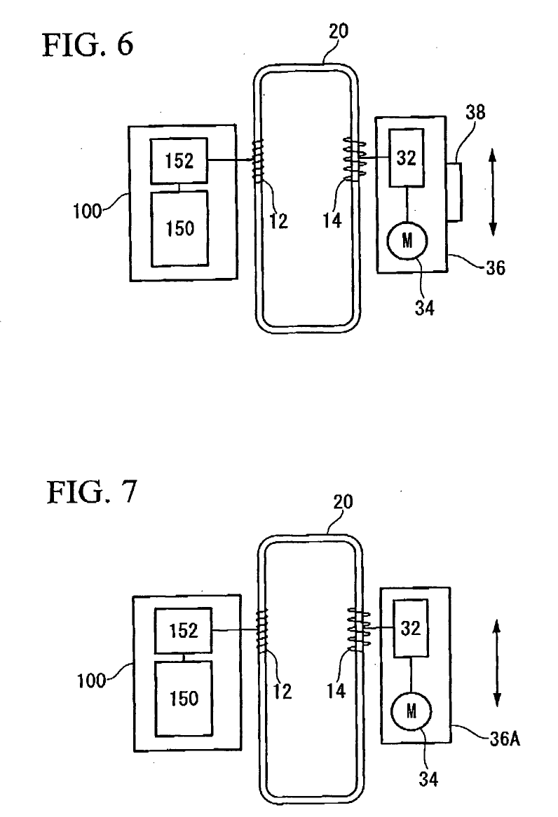

FIG. 5 is a drawing that shows a fourth embodiment of the present invention, and it shows an electric power supplying and receiving apparatus that uses a rectangular roundness cut core in which the magnetic body is cut in two. A material with little magnetic flux leakage is used for the roundness cut core 22 of FIG. 5 in the way as in the first embodiment. The primary coil 12 in FIG. 5 is the same as in the first embodiment. In addition, the secondary coil 16 is the same as in the third embodiment. In addition, the roundness cut core 22 that has been cut in two is connected by expansion pipes or bellows pipes 24 at the cut portions. The primary coil 12 and the left side roundness cut core 22 are secured to the first member 1, which is the fixed side, and the secondary coil 16 and the right side roundness cut core 22 are secured to the second member 2, which is the moving side. Expansion pipes or bellows pipes 24, if it is an expandable status, may be provided on either the first member 1 or the second member 2, or they may be supported by a third member.

A magnetic fluid enters into the expansion pipe or the bellows pipe 24. The magnetic fluid is configured by ferromagnetic ultra fine particles such as high-density magnetite or Mn—Zn group compound ferrites being stably dispersed in a liquid in which water, carbonate oil or fluorine oil is used as the medium and also by three components of a surfactant securely chemically adsorbed to the surface of the ferromagnetic ultra fine particles. Since the dispersed ferromagnetic ultra fine particles are very small, they are nearly the same as an ordinary liquid. The magnetic flux generated by the primary coil 12 passes through the roundness cut core 22, passes through the magnetic fluid of the expansion pipe or bellows pipe 24, and passes through the roundness cut core 22 where the secondary coil 16 is arranged. The core is a closed path even if there are no air gaps and two roundness act cores 22 are used.

Note that the magnetic fluid is not limited to the above type. In addition, it is also possible to use a substance other than magnetic fluid as long as it one that is able to reduce magnetic flux leakage resulting from air gaps.

If the load resistor 40 is a linear motor, and this linear motor is arranged so that it is able to drive the secondary coil 16 and the roundness cut core 22 of the secondary coil 16 in the direction of the arrows, it is possible to move the secondary coil 16 and the roundness cut core 22 of the secondary coil 16 in the direction of the arrows by means of voltage application to the primary coil 12. The distance “g” that they can be moved may be freely determined according to the expansion and contraction range of the expansion pipes or bellows pipes 24. In the case of the fourth embodiment, it is not necessary to arrange a low friction insulating member between the secondary coil 16 and the roundness cut core 22.

Note that, as in the third embodiment shown in FIG. 3, it is also possible to move the secondary coils 16 along the roundness cut core 22. In this case, it is necessary to provide a low friction insulating member 30 between the secondary coils 16 and the roundness cut core 22, for the load resistor 40 to be a linear motor, and for two linear motors to be arranged in a direction that intersects the magnetic flux of the roundness cut core 22 and in the same direction. In addition, it is also possible to cause expansion and contraction not only in the direction of the arrows shown in FIG. 5 but in the diagonal direction and to cease expansion and contraction so that an arc is formed according to the material and shape of the expansion pipes or bellows pipes.

In addition, it is also possible to use a configuration that interposes only magnetic fluid without providing expansion pipes or bellows pipes 24 between the roundness cut cores 22. In this case, the magnetic fluid is magnetically attracted to the roundness cut core 22 by of its own magnetic force, so it is possible to restrict magnetic flux leakage without providing air gaps between the roundness cut cores 22.

FIG. 6 shows a specific block diagram of the third embodiment.

A computation part 150, which computes signals such as in the stage signal processing discussed below, and a power source part 152, into which an AC power source of 200 V 100 V is input, are provided inside a fixed side controller 100 provided on a base. The primary coil 12 is connected to the power source part 152, and a signal transmission and reception part (not shown in the drawing) is connected to the computation part 150. The primary coil 12 is wound around the roundness core 20. On the other hand, the secondary coil 14 is wound around the roundness core 20 at the opposite side.

The secondary coil 14 is attached to the stage 36, and an object subject to movement 38 is loaded onto the stage 36. A drive motor 34 and a control circuit 32 that controls the drive motor are provided on the stage 36. The drive motor 34 moves the stage 36 in a direction (direction of the arrows) along the roundness core 20. For example, when a 60 HZ alternating current and 200V are applied to a primary coil 12 that has been wound N times, a magnetic flux is generated in the roundness core 20. There are no air gaps in the roundness core 20, so there is little magnetic flux leakage. With this, alternating-current electromotive in 60 Hz, 100 V is generated in a secondary coil 14 with N/2 windings by means of electromagnetic induction action. The drive motor 34 moves based on this, and the secondary coil 14 and the object subject to movement 38 move in conjunction with the stage 36.

Though not shown in the drawing, a guide member may be provided so that the stage 36 is accurately moved in a direction along the roundness core 20 (direction of the arrows). In addition, a sensor that measures the distance of movement of the stage 36 and a signal transmission and reception part are provided on the stage 36, the fact that the stage 36 has moved to the prescribed position is transmitted to the computation part 150, and supply of electric power of the power source part 152 of the fixed side controller 100 may also be stopped.

These guide members, sensors, etc. can be appropriately used as necessary even in the configurations shown in FIG. 1 through FIG. 3 and FIG. 5.

In addition, in FIG. 6, the secondary coil 14 has been given a configuration in which it is attached to the stage 36, but it may also otherwise be a configuration in which it is attached to a bogie 36A that conveys a substrate such as a wafer as shown in FIG. 7.

In this case, the bogie 36A is capable of self-propulsion in the direction of the arrows along the roundness core 20 by means of the electrical power transmitted from the power source part 152 without contact.

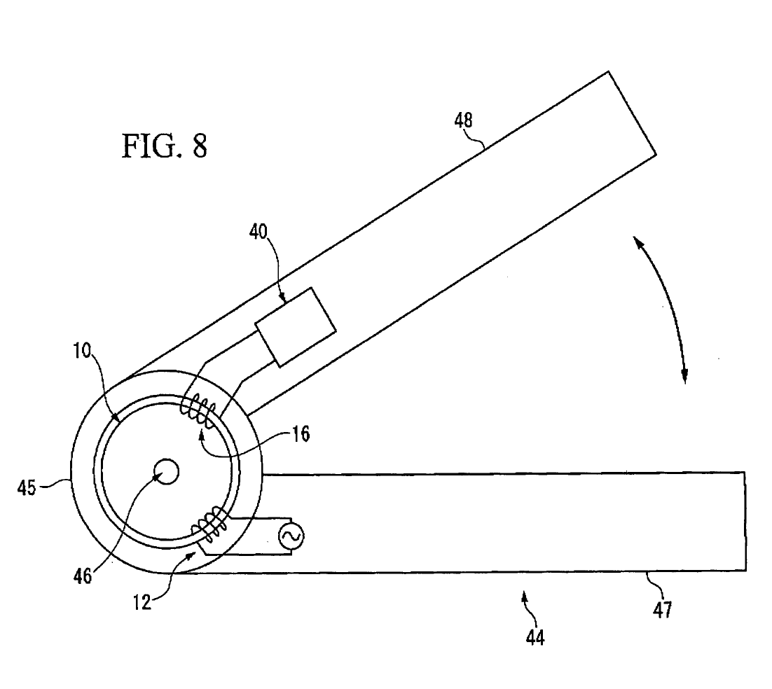

FIG. 8 shows a case in which the electric power supplying and receiving apparatus has been applied to a laptop personal computer 44. The primary coil 12, through which AC voltage is applied, and the secondary coil 16, through which AC current is generated, axe wound on the rig core 10. The secondary coil 16 is able to move along the circumferential diction of the ring core 10 with the rotation axis 46 as the center of rotation. The keyboard part 47 and the liquid crystal part 48 of the laptop personal computer 44 are connected by a hinge part 45, and the keyboard part 47 and the liquid crystal part 48 are mutually able to move in the direction of the arrows shown in FIG. 8. The ring core 10 is provided on the hinge part 45, the wound primary coil 12 is provided on the keyboard part 47, and the wound secondary coil 16 is provided on the liquid crystal part 48. A load resistor 40 such as a liquid crystal panel or a camera is attached to the secondary coil 16. When an AC power source is applied to the primary coil 12, magnetic flux occurs in ring core 10, and AC current is generated in the secondary coil 16. Through this, electric power is supplied to a load such as a liquid crystal panel or a camera.

When a cable, etc. is provided on the hinge part 45, and a keyboard part 47 and a liquid crystal part 48 are being mutually moved (opened and closed), there is concern that the cables, etc. will short. When the electric power supplying and receiving apparatus of the present invention is provided on the hinge part 45, it is possible to ensure long life and stability without concern for shorts. Note that, in the present embodiment, a laptop personal computer was used in the explanation, but it can be applied to various apparatuses or equipment as long as they have a member that has a hinge part and moves (opens and closes). Examples are portable telephones, digital cameras that have swivel mechanisms, or doors with monitoring cameras attached.

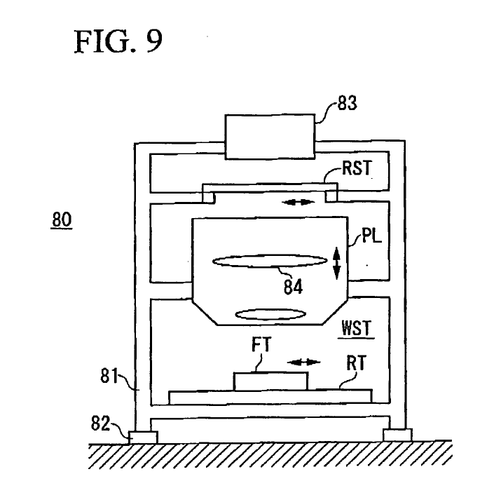

FIG. 9 shows a case in which the electric power supplying and receiving apparatus has been applied to a full field exposure system or step and scan system exposure appends 80 that manufactures semiconductor substances or liquid crystal substrates.

As shown in FIG. 9, the exposure apparatus 80 of the present embodiment is such that an illumination optical system 83, a reticle stage RST, which holds a reticle R as the mask, a projection unit PL, and a wafer stage WST, which holds a wafer as the substrate, are supported by a frame 81 mounted on a vibration-proofing stage 82.

For the exposure light, for example emission lines (g-ray, h-ray, i-ray), radiated for example from a mercury lamp, deep ultraviolet beams (DUV light beams) such as the KrF excimer laser beam (wavelength: 248 nm), and vacuum ultraviolet light beams (VUV light beans) such as the ArF excimer laser beam (wavelength: 193 nm) and the F₂ laser beam (wavelength: 157 nm), may be used. In this embodiment, the ArF excimer laser beam is used.

The exposure apparatus 80 is an apparatus that performs fine processing so precise positional adjustment, etc, is required. For this reason, the wafer stage WST is configured by a coarse movement stage RT, which performs movement over large distances, and a fine movement stage FT. In addition, it is necessary to perform fine movement of the reticle stage RST to superpose the pattern. In addition, the projection unit PL includes a plurality of optical elements (reflecting mirrors or convex lenses) held in a prescribed positional relationship within a lens barrel, but for example, for adjustment of the focus position and adjustment of aerial image or wave surface aberration, it is necessary to perform fine movement of the plurality of optical elements in the optical axis direction, etc. The arrow portions shown in FIG. 9 are locations where it is necessary to perform fine movement. In particular, the fine movement stage is driven by means of magnetic force or air bearings so that there is no contact whatsoever with other members. Therefore, it is preferable that it be applied to an electric power supplying and receiving apparatus of the present invention that is able to supply and receive electric power without contact.

It is possible to apply a stage 36 shown in FIG. 6 as a means of performing fine movement of this stage or optical elements 84. In addition, it goes without saying that the electric power supplying and receiving apparatus of the first embodiment, second embodiment or forth embodiment shown in FIG. 1, FIG. 2 or FIG. 5 may also be applied to the stage or optical elements 84. In addition, it is possible to use the present invention other than in exposure apse as well. For example, the present invention is also effective in stages, etc. of machine tools, which require precision.

Note that, in the respective embodiments, mainly the case in which electric power is transmitted as electrical utility was explained as an example, but it is not limited to this, and it may also be used in the transfer of electrical signals. Examples of electrical signals are control signals with respect to a load arranged on the second member 2 side, signals that indicate the drive status etc. of the load, and detection signals, etc. from sensor. The transmission of these electrical signals is not limited to transmission from the primary coil 12 to the secondary coil 14, 16, and transmission from the secondary coil 14, 16 to the coil 12 is also included. In addition, the electric power supply coil and the coil for sending and receiving electrical signals such as those discussed above may be configured in sub a way that they are respectively separately arranged or configured in such a way that independent coils are shared.

The fact that it is possible to add various changes to the present invention without deviating from the technical concepts and technical scope of the present invention should be clear to persons skilled in the art. For example, though this was explained in the embodiment in which the secondary coil is arranged on the second member 2, which moves, the prim coil 12 may be arranged on the second member 2, and the secondary coil 14 or 16 may be arranged on the fire member 1, which is the fixed side.

Note that applicable as the substrate of the aforementioned respective embodiments are not only semiconductor wafers for the fabrication of semiconductor devices but a substrates for display devices, ceramic wafers for thin-film magnetic heads, base plates of masks or reticles used in exposure apparatus (synthetic quartz, silicon wafers), etc.

Applicable as the exposure apparatus 80 are, in addition to step and repeat system projection exposure apparatuses (steppers) that full field expose the pattern of the reticle in a status in which the reticle (mask) and the wafer have been made stationary and sequentially step move the wafer, step and scan system scans exposure apparatus (scanning steppers) that synchronously move the reticle and the wafer to scan expose the patter of the reticle. In addition, for the exposure ads 80, also possible is application to a step and stitch system exposure apparatus that partially superposes and transfers at least two patterns on the wafer and sequentially moves the wafer.

In addition, the present invention can also be applied to twin-stage type exposure apparatus in which a plurality of wafer stages are provided. The structure and the exposure operations of twin-stage type exposure apparatus are disclosed in, for example, Japanese Unexamined Patent Application Publication No. 10-163099, Japanese Unexamined Patent Application Publication No. 10-214783 (corresponds to U.S. Pat. Nos. 6,341,007, 6,400,441, 6,549,269 and 6,590,634), Published Japanese Translation No. 2000-505958 of PCT International Application (corresponding to U.S. Pat. No. 5,696,411), and U.S. Pat. No. 6,208,407. In addition, the preset invention may also be applied to the wafer stage as disclosed in PCT International Publication No. WO 2005/122242.

In addition, as disclosed in Japanese Unexamined Patent Application Publication No. 11-135400 (corresponding to PCT International Patent Publication No. WO 1999/23692), and Japanese Unexamined Patent Application Publication No. 2000-164504 (corresponding to U.S. Pat. No. 6,897,963), the preset invention may also be applied to an exposure apparatus comprising a measuring stage that has built in a substrate stage, which holds the substrate, a reference member, on which a reference mark is formed, and various photosensors.

The movement mirror for the reticle stage may include not only a plane mirror, but also a corner cube (retroreflector), and instead of securing the movement mirror to the reticle stage, a mirror surface may be used which is formed by mirror polishing for example the end face (side face) of the reticle stage. Furthermore, the reticle stage may be of a construction capable of coarse/fine movement as disclosed for example in Japanese Unexamined Patent Application, First Publication No. H08-130179 (corresponding U.S. Pat. No. 6,721,034).

The detail of the configuration in which the laser interferometer is capable of measuring the position in the Z axis direction of the wafer stage, and the rotation information in the θX and the θY directions is disclosed for example in Japanese Unexamined Patent Application, First Publication No. 2001-510577 (corresponding PCT International Publication No. 1999/128790). Furthermore, instead of fixing the movement mirror to the wafer stage, a reflection surface may be used where for example a part of the wafer stage (the side face or the like) is formed by a mirror polishing process.

When for example the laser interferometer is capable of measuring the position information for the Z axis, the θX, and the θY directions of the wafer W, then it is possible to measure the position information for the Z axis direction during the exposure operation of the wafer W, and hence the focus leveling detection system need not be provided, and position control of the wafer W in relation to the Z axis, the θX, and the θY directions can be performed using the measurement results of the laser interferometer, at least during the exposure operation.

Moreover, the present invention can be applied to an exposure apparatus and an exposure method which does not use a projection optical system. Even in the case where a projection optical system is not used, the exposure light can be shone onto the substrate via optical members such as a mask and lean.

In addition, the present invention may also be applied to a s-called liquid immersion exposure apparatus that locally fills liquid between a projection optical system and a substrate and exposes the subs and via the liquid. A liquid immersion exposure apparatus is disclosed in the International Publication No. WO 99/49504. In addition, the present invention may also be applied to a liquid immersion exposure apparatus that performs exposure in a status in which the entire surface of the substrate subject to exposure is immersed in liquid as disclosed in, for example, Japanese Unexamined Patent Application Publication No. HO6-124873, Japanese Unexamined Patent Application Publication No. H10-303114 and U.S. Pat. No. 5,825,043.

The types of exposure apparatus 80 are not limited to exposure apparatus for semiconductor device fabrication that expose a semiconductor device pattern onto a substrate but are also widely applicable to exposure apparatus for the manufacture of liquid crystal display elements and for the manufacture of displays, and exposure apparatuses for the manufacture of thin film magnetic heads, image pickup elements (CCDs), micro machines, MEMS, DNA chips, or reticles or masks.

Note that, in the embodiments discussed above, a light transmitting type mask in which a prescribed light shielding pattern (or phase pattern/light reduction pattern) has been formed on a light transmissive substrate is used. However instead of this mask, for example as disclosed in U.S. Pat. No. 6,778,257, an electronic mask (called a variable form mask; for example this includes a DMD (Digital Micro-mixer Device) as one type of non-radiative type image display element) for forming a transmission pattern or reflection pattern, or a light emitting pattern, based on electronic data of a patter to be exposed may be used.

Furthermore the present invention can also be applied to an exposure apparatus (lithography system) which exposes run-and-space pattern on a substrate P by forming interference fringes on the substrate P, as disclosed for example in PCT International Patent Publication No. WO 2001/1035168.

Moreover, the present invention can also be applied to an exposure apparatus as disclosed for example in Published Japanese Translation No. 2004-519850 (corresponding U.S. Pat. No. 6,611,316), which combines patterns of two masks on a substrate via a projection optical system, and double exposes a single shot region on the substrate at substantially the same time, using a single scan exposure light.

The exposure apparatus of the present embodiment is manufactured by assembling various subsystems, including the retie constituent elements, so that the presented mechanical precision, electrical precision and optical precision are maintained. To ensure these respective precisions, performed before and after this assembly are adjustments for achieving optical precision with respect to the various optical systems, adjustments for achieving mechanical precision with respect to the various mechanical systems, and adjustments for achieving electrical precision with respect to the various electrical systems. The process of assembly from the various subsystems to the exposure apparatus includes mechanical connections, electrical circuit wiring connections, air pressure circuit piping connections, etc. among the various subsystems. Obviously, before the process of assembly from these various subsystems to the exposure apparatus, there are the processes of individual assembly of the respective subsystems. When the process of assembly of the various subsystems into the exposure apparatus has ended, overall adjustment is performed, and the various precisions are ensured for the exposure apparatus as a whole. Note that it is preferable that the manufacture of the exposure apparatus be performed in a clean room in which the temperature, the degree of cleanliness, etc. am controlled.

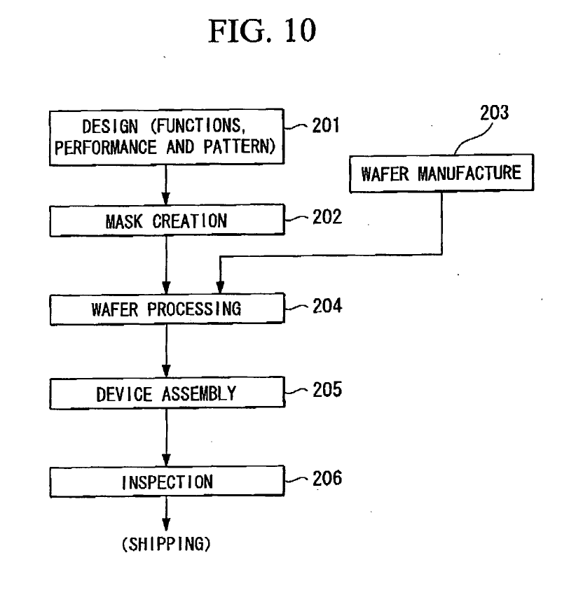

As shown in FIG. 10, microdevices such as semiconductor devices are manufactured by going through a step 201 that performs microdevice fraction and performance design, a step 202 that creates a mask (reticle) based on this design step, a step 203 that manufactures a substrate that is the device base material, a step 204 including substrate processing steps such as a process that exposes the pattern on the mask onto a substrate by means of the exposure apparatus 80 of the aforementioned embodiments, a process for developing the exposed substrate, and a process for heating (curing) and etching the developed substrate, a device assembly step (including a dicing process, a bonding process and a packaging process) 205, and an inspection step 206, etc.

With the present invention, there is an effect in that it is possible to efficiently transfer electrical utility such as electric power in which there is little magnetic flux leakage without contact in a status in which the first member and the second member are capable of relative movement.

What is claimed is:

1. A utility transfer apparatus, comprising:
a magnetic member being secured to a first member;
a first coil provided on the first member and wound on the magnetic member; and
a second coil provided on a second member and wound on the magnetic member so that the second member is movable relative to the first member, wherein
the magnetic member forms a magnetic circuit that does not have an air gap.

2. The utility transfer apparatus according to claim 1, wherein a prescribed gap is formed between the second coil and the magnetic member.

3. The utility transfer apparatus according to claim 1, wherein the magnetic member includes silicon steel.

4. The utility transfer apparatus according to clam 1, wherein the magnetic member is divided between a winding part of the first coil and a winding part of the second coil by interposing a magnetic fluid.

5. The utility transfer apparatus according to claim 4, wherein
a prescribed gap is formed between the second coil and the magnetic member, and
the magnetic fluid expands and contracts by at least a distance being same as the prescribed gap.

6. The utility transfer apparatus according to claim 4, wherein the magnetic fluid includes a liquid in which magnetite or Mn—Zn compound ferrites, silicon steel, and kerosene have been dispersed in water.

7. The utility transfer apparatus according to claim 1, wherein the first member and the second member relatively rotationally move about an axis of rotation.

8. The utility transfer apparatus according to claim 7, wherein the first member and the second member are provided with a hinge part and freely fold up.

9. A utility transfer apparatus, comprising:
a first member,
a second member that is movable relative to the first member;
a magnetic member that is secured to one of the first member or the second member and forms a closed magnetic circuit;
a first coil that is provided on the first member and is wound on the magnetic member, and
a second coil that is provided on the second member and is wound on the magnetic member so as to be capable of relative movement with respect to the magnetic member.

10. The utility transfer apparatus according to claim 9, wherein a prescribed gap is formed between the second coil and the magnetic member.

11. The utility transfer apparatus according to claim 9, wherein the magnetic member is provided in an undivided status.

12. The utility transfer apparatus according to claim 9, wherein the magnetic member includes silicon steel.

13. The utility transfer apparatus according to claim 9, wherein the magnetic member is divided between a ding part of the first coil and a winding part of the second coil by interposing a magnetic fluid.

14. The utility transfer apparatus according to claim 13, wherein
a prescribed gap is formed between the second coil and the magnetic member, and
the magnetic fluid expands and contract by at least a distance being same as the prescribed gap.

15. The utility transfer apparatus according to claim 13, wherein the magnetic fluid includes a liquid in which magnetite or Mn—Zn compound ferrites, silicon steel, and kerosene have been dispersed in water.

16. The utility transfer apparatus according to claim 9, wherein the first member and the second member relatively rotationally move about an axis of rotation.

17. The utility transfer apparatus according to clam 16, wherein the first member and the second member are provided with a hinge part and freely fold up.

18. The utility transfer apparatus according to claim 9, wherein the second coil is able to move along a don of the magnetic circuit formed on the magnetic member.

19. The utility transfer a according to claim 9, wherein the second coil is able to move in a crossing direction to a direction of the magnetic circuit formed on the magnetic member.

20. A utility transfer apparatus, comprising:
a first member;
a second member that is movable relative to the first member,
a magnetic member that is secured to one of the first member or the second member;
a first coil that is provided on the first member and is wound on the magnetic member, and
a second coil that is provided on the second member and is wound on the magnetic member so that the second member is movable relative to the first member, wherein
the second coil moves in a crossing direction to a direction of a magnetic circuit formed on a part of the magnetic member on which the second coil is wound.

21. A stage apparatus that comprises a utility transfer apparatus according to claim 1.

22. The stage apparatus according to claim 21, further comprising:
a first mover, and a second mover capable of relative movement with respect to the first mover, wherein
the utility transfer apparatus transfers utilities between the first mover and the second mover.

23. An exposure apparatus that comp a utility transfer apparatus according to claim 9.

24. An exposure apparatus that comprises a stage apparatus according to claim 21.

25. A device manufacturing method that use an exposure apparatus according to claim 23.
